(19) United States
(12) Patent Application Publication
(10) Pub. No.: US 2015/0004083 A1
(43) Pub. Date: Jan. 1, 2015

(54) INJECTOR BOSS AND SYSTEM AND METHOD OF INJECTING LIQUID INTO A GAS STREAM

(71) Applicants: Andrei Makartchouk, Hinsdale, IL (US); Matthew Jenski, Roselle, IL (US); Adam C. Lack, Willow Springs, IL (US)

(72) Inventors: Andrei Makartchouk, Hinsdale, IL (US); Matthew Jenski, Roselle, IL (US); Adam C. Lack, Willow Springs, IL (US)

(73) Assignee: International Engine Intellectual Property Company, LLC, Lisle, IL (US)

(21) Appl. No.: 14/373,502

(22) PCT Filed: Jan. 26, 2012
(86) PCT No.: PCT/US12/22681

§ 371 Date: Jul. 21, 2014

(51) Int. Cl. B01D 53/94; F16L 55/00

(52) U.S. Cl. CPC B01D 53/9431; F16L 55/00; B01D 53/94; B01D 2255/00
USPC 423/212; 285/119; 422/168

(57) ABSTRACT

An injector boss (114) for mounting an injector (110) that injects liquid reductant (U) into a flow of exhaust gas (EG) in an exhaust pipe (116) includes at least one sidewall (124) and a boss foundation (126). The boss foundation (126) is generally perpendicular to the at least one sidewall (124), and the at least one sidewall and the boss (114) define an internal area (120). A spray guard (132) extends from the boss foundation (126) into the internal area (120). The spray guard (132) h a first opening (138) for receiving liquid reductant (U) from the injector (110), and a second opening (140) for emitting liquid reductant into the internal area (120).

### BACKGROUND

Embodiments described herein relate to an injector boss, system and method for injecting an emission liquid reductant into a gas stream. More specifically, embodiments described herein relate to an injector boss, system and method for injecting emission reductant, such as urea, into a gas stream of an aftertreatment system, such as an SCR system.

Typically, urea selective catalytic reduction systems (urea SCR systems) are used to reduce oxides of Nitrogen (NOₓ) from diesel engines. Urea SCR systems typically rely on injection of 32.5% aqueous urea solution into the exhaust line of a vehicle upstream of an SCR catalyst. In the SCR catalyst, the NO is decomposed by the ammonia, and the emission from the catalyst is N₂, H₂O and CO₂.

At the time of injection, the urea solution temperature is typically close to ambient, and is usually less than 60° C. The SCR reaction requires gaseous ammonia. To produce the gaseous ammonia, the injected urea solution is heated to 150° C. to evaporate the water and decompose the remaining urea into ammonia and isocyanic acid. If the evaporation and the decomposition are not complete, the SCR catalyst performance is reduced due to insufficient availability of reductant.

Referring to FIG. 1, a urea injector 10 for an SCR system 12 may be installed on a boss 14 that is attached to an exhaust pipe 16 and in fluid communication with the engine exhaust gas EG. For efficient performance of the SCR catalyst 18 that is located downstream of the injector 10, the urea is injected into the engine exhaust gas EG, vaporized and decomposed before the inlet of the catalyst 18. The urea is sprayed into the internal area 20 of the boss 14 and into the exhaust pipe 16, but the urea is corrosive when the urea contacts the metal of the boss and the exhaust pipe. Solid deposits of urea can be formed in the internal surface of the boss 14 and the exhaust pipe 16, and may cause the boss to become plugged. The urea can also cause rust and complete failure of the SCR system 12.

### SUMMARY

An injector boss for mounting an injector that injects liquid reductant into a flow of exhaust gas in an exhaust pipe includes at least one sidewall and a boss foundation. The boss foundation is generally perpendicular to the at least one sidewall, and the at least one sidewall and the boss define an internal area. A spray guard extends from the boss foundation into the internal area. The spray guard has a first opening for receiving liquid reductant from an injector, and a second opening for emitting spray into the internal area.

An SCR System for injecting a liquid reductant includes an exhaust pipe having an internal area for delivering a flow of exhaust gas to a catalyst. The system also includes an injector for injecting the liquid reductant into the exhaust pipe upstream of the catalyst, and a boss having an internal area that is in fluid communication with the internal area of the exhaust pipe. A spray guard extends from the boss into the internal area of the boss. The injector is mounted on the boss and introduces the liquid reductant through the spray guard and into the exhaust pipe.

A method for injection of a liquid reductant into an exhaust gas includes providing an exhaust pipe having an internal area, and delivering a flow of exhaust gas through the internal area of the exhaust pipe. The method includes the step of disposing a boss having an internal area in fluid communication with the internal area of the exhaust pipe. The method also includes the steps of extending a spray guard from the boss into the internal area of the boss, and injecting liquid reductant through the spray guard and into the exhaust pipe.

### BRIEF DESCRIPTION OF THE DRAWINGS

FIG. 1 is a prior art boss for receiving an injector that injects liquid into a gas flow.

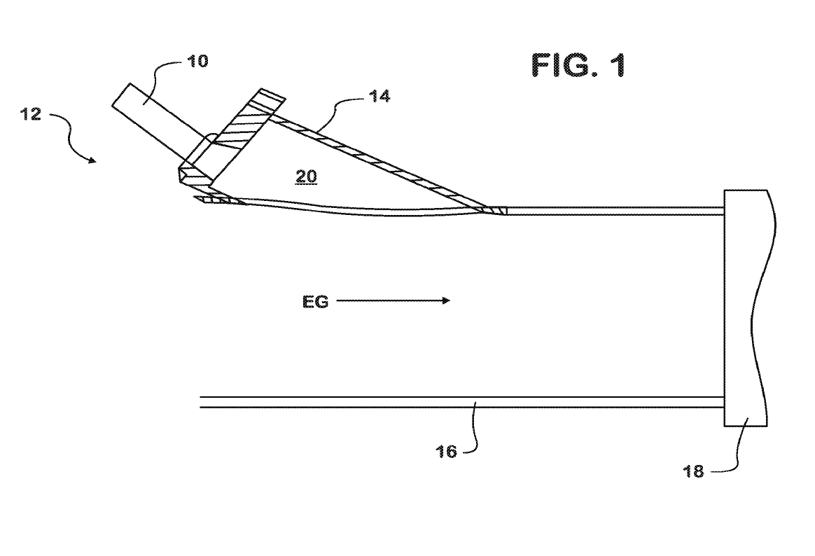

FIG. 2 is a boss having a spray guard for directing the spray from the injector into the gas flow.

### DETAILED DESCRIPTION

While the following description will describe a boss 114 for receiving a urea injector 110 of an SCR system 112, where the injector injects liquid urea U into an exhaust gas flow EG, it should be appreciated that the boss and the injector may be used to inject any liquid reductant into any gas stream.

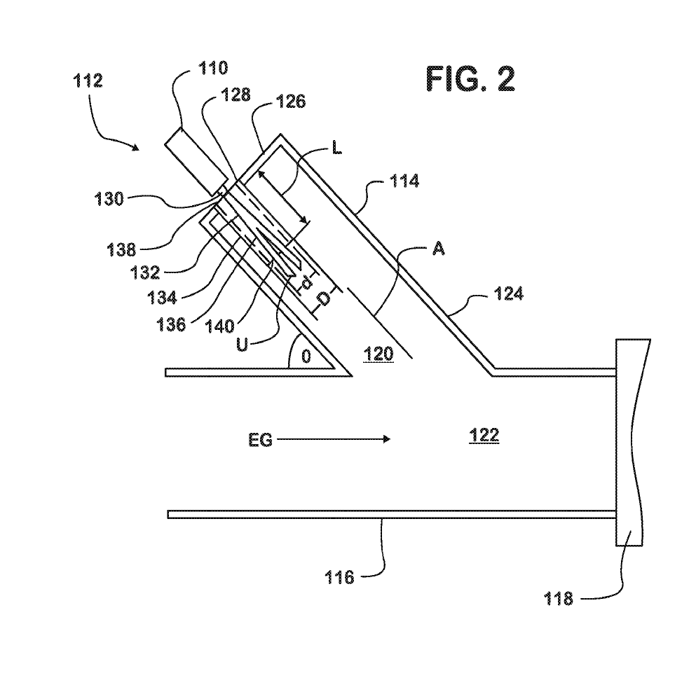

Referring now to FIG. 2, the SCR system 112 has an exhaust pipe 116 that is in fluid communication with and upstream of a catalyst 118 for delivering a flow of exhaust gas EG to the catalyst. The injector 110 is mounted on the boss 114, which has a generally enclosed internal area 120 that is in fluid communication with an internal area 122 of the exhaust pipe 116 and the exhaust gas EG in the exhaust pipe. In this configuration, urea U that is sprayed from the injector 110 is in fluid communication with the exhaust gas EG at the internal area 120 of the boss 114 and at the internal area 122 of the exhaust pipe 116. The exhaust gas EG generally flows in the direction indicated by the arrow in FIG. 2.

The boss 114 has a generally cylindrical shape having a sidewall 124 that forms an acute angle θ with respect to the exhaust pipe 116, and an axis A, although other shapes and orientations are possible. The boss 114 also has a boss foundation 126 that is generally perpendicular to the at least one sidewall 124 for receiving the injector 110.

The boss foundation 126 forms a top surface of the boss 114, and defines an aperture 128 for receiving the injector 110. A nozzle 130 of the injector is received at the aperture 128 for introducing the urea spray U into the boss 114. While the aperture 128 is not centered on the boss foundation 126, it is possible that the aperture can be centered, or can be at other locations on the boss foundation.

A spray guard 132 is disposed in the aperture 128, and extends generally parallel with the axis A of the boss 114 into the internal area 120. Alternatively, the spray guard 132 may be integrally formed with the boss foundation 126. The spray guard 132 has a generally cylindrical, hollow shape with an exterior surface 134 and an interior surface 136. The spray guard 132 may be a pipe, a rigid tube, or any other hollow cylinder that permits the spray of urea U from a first opening 138 to a second opening 140. The first opening 138 is configured to receive the urea U, and the second opening 140 is configured to emit the urea. The nozzle 130 of the injector is received in the first opening 138 of the spray guard 132, however it is also possible that the nozzle 130 may be spaced a short distance from the first opening.

While the dimensions of the spray guard 132 may be modified depending on the dimensions and geometries of the boss 114 and the injector 110, an exemplary spray guard for one commonly used boss and injector will be described below. The spray guard 132 may have a length L of about 24.5 mm, an exterior diameter D of about 12.7 mm, and a center-to-center diameter d of about 11.5 mm, however other dimensions are possible. The interior surface 136 of the spray guard 132 may have a constant diameter, or alternatively, may have an increasing diameter from the first opening 138 to the second opening 140. Further, the interior surface 136 may have a non-cylindrical shape.

When the urea U is sprayed from the injector 110 into the boss 114 having the spray guard 132, the boss foundation 126 and at least a portion of the sidewall 124 are protected from receiving the spray of urea U, and deposits of solid urea forming at these locations are reduced or prevented. With the spray guard 132, sprayed urea U is directed towards the internal area 122 of the exhaust pipe 116, and urea does not impinge on at least a portion of the sidewall 124, or alternatively, dose not impinge on any portion of the sidewall 124. The portion of the sidewall 124 that is protected from the urea U is dependent on the dimensions of the spray guard 132. The spray guard 132 can be used to direct the spray of urea U so that the amount of urea impinging on the boss 114 is reduced or even prevented. Further, by directing the spray of urea U generally parallel to the axis A, the urea has a longer residence time in the boss 114, allowing the liquid urea more time to heat up and to vaporize.

If the spray guard 132 becomes plugged with solid urea deposits, the spray guard can be cleaned. Alternatively, the spray guard can be replaced by removing the spray guard 132 from the aperture 128 of the boss foundation 126.

What is claimed is:

1. An injector boss for mounting an injector that injects liquid reductant into a flow of exhaust gas in an exhaust pipe, the boss comprising:
at least one sidewall;
a boss foundation generally perpendicular to the at least one sidewall, the at least one sidewall and the boss defining a generally enclosed internal area;
a spray guard extending from the boss foundation into the internal area, the spray guard having a first opening for receiving liquid reductant from the injector, and a second opening for emitting liquid reductant into the internal area.

2. The injector boss of claim 1 wherein the boss has a generally cylindrical shape.

3. The injector boss of claim 1 wherein the spray guard has a generally cylindrical shape.

4. The injector boss of claim 1 wherein the boss foundation defines an aperture, and the spray guard is disposed in the aperture.

5. The injector boss of claim 1 wherein the spray guard extends generally parallel with the at least one sidewall of the boss.

6. The injector boss of claim 1 wherein the spray guard is integrally formed with the boss.

7. An SCR System for injecting a liquid reductant into a flow of exhaust gas, the SCR system comprising:
an exhaust pipe having an internal area for delivering a flow of exhaust gas to a catalyst;
an injector for injecting the liquid reductant into the exhaust pipe upstream of the catalyst;
a boss having an internal area that is in fluid communication with the internal area of the exhaust pipe; and
a spray guard extending from the boss into the internal area of the boss, wherein the injector is mounted on the boss for introducing the liquid reductant through the spray guard and into the exhaust pipe.

8. The SCR system of claim 7 wherein the spray guard is generally cylindrical.

9. The SCR system of claim 7 wherein the boss is generally cylindrical.

10. The SCR system of claim 7 wherein the injector further comprises a nozzle that is received by the spray guard.

11. The SCR system of claim 7 wherein the spray guard further comprises a first opening for receiving liquid reductant from the injector, and a second opening for emitting liquid reductant into the internal area of the boss.

12. The SCR system of claim 7 wherein the spray guard directs the spray of liquid reductant into the internal area of the exhaust pipe.

13. The SCR system of claim 7 wherein the liquid reductant is urea.

14. A method for injection of a liquid reductant into an exhaust gas, the method comprising:
providing an exhaust pipe having an internal area;
delivering a flow of exhaust gas through the internal area of the exhaust pipe;
disposing a boss having an internal area in fluid communication with the internal area of the exhaust pipe;
extending a spray guard from the boss into the internal area of the boss; and
injecting liquid reductant through the spray guard and into the exhaust pipe.

15. The method of claim 14 further comprising delivering exhaust gas to a catalyst.

16. The method of claim 15 further comprising injecting the liquid reductant upstream of the catalyst.

17. The method of claim 14 further comprising receiving the liquid reductant at a first opening of the spray guard, and emitting the liquid reductant at a second opening of the spray guard.

18. The method of claim 14 further comprising directing the spray of liquid reductant into the internal area of the exhaust pipe.

19. The method of claim 14 further comprising preventing the impingement of urea at at least a portion of a sidewall of the boss.

20. The method of claim 14 wherein the step of injecting liquid reductant further comprises disposing a nozzle of an injector at a first opening of the spray guard.
